(19) United States
(12) Patent Application Publication
(10) Pub. No.: US 2007/0128373 A1
(43) Pub. Date: Jun. 7, 2007

(54) Electroless plating apparatus and electroless plating method

(75) Inventors: Kenichi Hara, Nirasaki-shi (JP); Mitsuaki Iwashita, Nirasaki-shi (JP); Takehiko Orii, Nirasaki-shi (JP); Takayuki Toshima, Koshi-shi (JP)

Correspondence Address: SMITH, GAMBRELL & RUSSELL, 1850 M STREET, N.W., SUITE 800, WASHINGTON, DC, 20036, US

(73) Assignee: Tokyo Electron Limited

(21) Appl. No.: 11/606,158

(22) Filed: Nov. 30, 2006

(30) Foreign Application Priority Data
Dec. 2, 2005 (JP) JP 2005-349607

(51) Int. Cl. B05D 5/12; B05D 3/04; B05D 1/18; B05C 11/00; B05B 3/00

(52) U.S. Cl. 427/443.1; 427/437; 427/304; 427/99.5; 118/666; 118/323; 427/8

(57) ABSTRACT

An electroless plating apparatus which supplies a plating solution to a top surface of a substrate to effect electroless plating, comprises a substrate support section which supports a substrate, a plating-solution retaining section which retains the plating solution to be supplied to the top surface of the substrate, a plating-solution feeding pipe which guides the plating solution from the plating-solution retaining section to the top surface of the substrate supported by the substrate support section, a plating-solution temperature controlling mechanism which controls a temperature of the plating solution flowing in the plating-solution feeding pipe, and a suction mechanism which sucks the plating solution in the plating-solution feeding pipe toward the plating-solution retaining section when feeding of the plating solution to the top surface of the substrate through the plating-solution feeding pipe is stopped.

### BACKGROUND OF THE INVENTION

1. Field of the Invention

The present invention relates to an electroless plating apparatus and an electroless plating method which supply a plating solution to the top surface of a substrate to effect electroless plating.

2. Description of the Related Art

The use of Cu (copper) for wires to be formed on a semiconductor wafer as a substrate is becoming popular in the fabrication process for semiconductor devices in order to improve the operational speed thereof. The formation of Cu wires on a substrate is generally carried out by a damascene process which forms vias and trenches to bury wires in an insulating film and bury Cu wires in the vias and trenches.

Semiconductor devices having such Cu wires are having ever-finer microfabrication patterns and ever-higher integration resulting in an increased current density. This increases current-based migration of Cu atoms, so-called electromigration, which may lead to disconnection of wires, lowering the reliability.

Accordingly, there is an attempt to improve the electromigration durability of semiconductor devices by coating a metal plated film called a cap metal on the top surfaces of Cu wires by electroless plating. There is a known electroless plating method according to which a plating target is dipped in a tank retaining a plating solution. The use of such a method to plating of wires formed on a substrate brings about adhesion of the plating solution to the bottom (back side) of a semiconductor wafer on a substrate, causing contamination.

There has been proposed an apparatus which effects electroless plating while suppressing contamination (see, for example, Japanese Patent Laid-Open Publication No. 2004-124235). This apparatus includes a chuck which supports a substrate, a lower plate which heats up the substrate supported on the chuck to a predetermined temperature, and a plating-solution feeding pipe (processing liquid inlet portion) in which a plating solution heated to the predetermined temperature flows to be fed onto the substrate heated by the lower plate.

In general, in an electroless plating process, a plating solution should be heated at a temperature of 50° C. or higher and a boiling point or lower and should then contact a plating target. Because the plating solution, when heated, increases the chemical stability, and is altered and degraded, however, it is preferable to feed the plating solution onto a substrate at as low a heating temperature as possible, e.g., 60 to 80° C. or so.

However, the electroless plating apparatus should have the plating solution heating temperature set relatively high in consideration of temperature drop while flowing in a plating-solution feeding pipe. What is more, the time for a plating solution o flow in the plating-solution feeding pipe varies due to interruption of supply of the plating solution or the like. This requires that the temperature of the plating solution should be kept high, thus making it difficult to keep the plating solution at high quality.

While it is preferable to effect strict temperature control of a substrate at the time of plating in order to make the film property of a plated film better in the electroless plating technology, the conventional electroless plating apparatus should not necessarily achieve sufficient temperature control.

### BRIEF SUMMARY OF THE INVENTION

Accordingly, it is an object of the invention to provide an electroless plating apparatus and an electroless plating method which can keep a plating solution at high quality.

It is another object of the invention to provide an electroless plating apparatus and an electroless plating method which can form a plated film with a good film property.

It is a further object of the invention to provide a computer readable storage medium storing a control program which can execute such an electroless plating method.

According to the first aspect of the invention, there is provided an electroless plating apparatus which supplies a plating solution to a top surface of a substrate to effect electroless plating, comprising a substrate support section which supports a substrate; a plating-solution retaining section which retains the plating solution to be supplied to the top surface of the substrate; a plating-solution feeding pipe which feeds the plating solution from the plating-solution retaining section toward the top surface of the substrate supported by the substrate support section; a plating-solution discharge nozzle which is provided at the plating-solution feeding pipe and discharges the plating solution to the top surface of the substrate; a plating-solution temperature controlling mechanism which controls a temperature of the plating solution flowing in the plating-solution feeding pipe; and a suction mechanism which sucks the plating solution in the plating-solution feeding pipe toward the plating-solution retaining section.

In the first aspect of the invention, the plating-solution temperature controlling mechanism can be configured to have a temperature controlling portion covering at least a part of the plating-solution feeding pipe, and the suction mechanism can be configured to suck the plating solution in the plating-solution feeding pipe toward the plating-solution retaining section until the plating solution passes the temperature controlling portion of the plating-solution temperature controlling mechanism. In this case, the temperature controlling portion of the plating-solution temperature controlling mechanism may be a plating-solution temperature controlling pipe which controls the temperature of the plating solution flowing in the plating-solution feeding pipe as a temperature-controlled fluid whose temperature is controlled to a predetermined temperature flows inside the plating-solution temperature controlling pipe. The plating-solution temperature controlling pipe in use can be configured to have a double-pipe structure having an inner pipe and an outer pipe, so that the temperature-controlled fluid having flowed in one of the inner pipe and the outer pipe flows back in an other one of the inner pipe and the outer pipe.

In the first aspect of the invention, the plating-solution temperature controlling mechanism can be configured to have a temperature controlling portion covering at least a part of the plating-solution feeding pipe, and a heat source which is provided at a portion between the temperature controlling portion and the plating-solution retaining section and heats the plating solution, and the suction mechanism can be configured to suck the plating solution in the plating-solution feeding pipe toward the plating-solution retaining section until the plating solution passes the heat source. In this case, the temperature controlling portion of the plating-solution temperature controlling mechanism may be a plating-solution temperature controlling pipe which controls the temperature of the plating solution flowing in the plating-solution feeding pipe as a temperature-controlled fluid whose temperature is controlled to a predetermined temperature flows inside the plating-solution temperature controlling pipe. The plating-solution temperature controlling pipe in use can be configured to have a double-pipe structure having an inner pipe and an outer pipe, so that the temperature-controlled fluid having flowed in one of the inner pipe and the outer pipe flows back in an other one of the inner pipe and the outer pipe.

The electroless plating apparatus according to the first aspect of the invention further can comprise a chamber which retains the substrate supported by the substrate support section. The electroless plating apparatus can further comprise a moving mechanism which moves the plating-solution feeding pipe in such a way that the plating-solution discharge nozzle moves between a process position on the substrate and a retreat position where the plating-solution discharge nozzle is retreated from the substrate. In this case, the electroless plating apparatus can further comprise a nozzle storing chamber which is provided adjacent to the chamber and stores the plating-solution discharge nozzle moved to the retreat position by the moving mechanism.

In the first aspect of the invention, the electroless plating apparatus can be configured to further comprise a preprocess-liquid feeding mechanism which feeds a predetermined liquid to the substrate prior to feeding of the plating solution to a top surface thereof; and a postprocess-liquid feeding mechanism which feeds a predetermined liquid to the substrate after feeding of the plating solution to the top surface thereof. The electroless plating apparatus can be configured to further comprise a substrate temperature control member which is provided, in a connectable and disconnectable manner, on a bottom side of the substrate supported by the substrate support section, and controls the temperature of the substrate while being close thereto by feeding a temperature-controlled fluid whose temperature is controlled to a predetermined temperature. In this case, the substrate temperature control member may have a function of feeding a dry gas to the substrate.

In the first aspect of the invention, the electroless plating apparatus can be configured to further comprise a postprocess-liquid feeding mechanism which feeds a postprocess liquid to the substrate supported by the substrate support section after feeding of the plating solution to the top surface thereof, and the substrate temperature control member can be configured to move downward away from the substrate when or after the postprocess-liquid feeding mechanism feeds the postprocess liquid to the top surface of the substrate, and then move upward to come close to the substrate again while feeding the dry gas to a bottom side of the substrate from a fluid feeding port, thereby drying the substrate.

According to the second aspect of the invention, there is provided an electroless plating apparatus which supplies a plating solution to a top surface of a substrate to effect electroless plating, comprising a substrate support section which supports a substrate; a plating-solution retaining section which retains the plating solution to be supplied to the top surface of the substrate; a plating-solution feeding pipe which feeds the plating solution from the plating-solution retaining section toward the top surface of the substrate supported by the substrate support section; a plating-solution discharge nozzle which is provided at the plating-solution feeding pipe and discharges the plating solution to the top surface of the substrate; a substrate temperature control member which is provided on a bottom side of the substrate supported by the substrate support section, and controls a temperature of the substrate; and a moving mechanism which causes the substrate temperature control member and the substrate to take a relative lift up/down motion.

According to the second aspect of the invention, the substrate temperature control member can incorporate a heater, and heat up the substrate with radiation heat to thereby control the temperature of the substrate to a predetermined temperature. In this case, the substrate temperature control member can control the temperature of the substrate as a distance between the substrate temperature control member and the substrate is adjusted by the moving mechanism.

In the second aspect of the invention, the electroless plating apparatus can be configured to further comprise a preprocess-liquid feeding mechanism which feeds a predetermined liquid to the substrate prior to feeding of the plating solution to a top surface thereof; and a postprocess-liquid feeding mechanism which feeds a predetermined liquid to the substrate after feeding of the plating solution to the top surface thereof.

According to the third aspect of the invention, there is provided an electroless plating method which performs electroless plating by supplying a plating solution retained in a plating-solution retaining section to a top surface of a substrate via a plating-solution feeding pipe and a plating-solution discharge nozzle, comprising controlling a temperature of the plating solution flowing in the plating-solution feeding pipe to a predetermined temperature; feeding the temperature-controlled plating solution to the top surface of the substrate; stopping feeding the plating solution to the top surface of the substrate from the plating-solution feeding pipe; and sucking the plating solution in the plating-solution feeding pipe toward the plating-solution retaining section.

In the third aspect of the invention, temperature control of the plating solution can be executed by a plating-solution temperature controlling mechanism having a temperature controlling portion covering at least a part of the plating-solution feeding pipe, and sucking of the plating solution can be carried out until the plating solution in the plating-solution feeding pipe passes at least the temperature controlling portion. Temperature control of the plating solution can be executed by a plating-solution temperature controlling mechanism having a temperature controlling portion covering at least a part of the plating-solution feeding pipe, and a heat source which is provided at a portion between the temperature controlling portion and the plating-solution retaining section and heats the plating solution, and sucking of the plating solution can be carried out until the plating solution in the plating-solution feeding pipe passes at least the heat source.

The electroless plating method according to the third aspect of the invention may further comprise controlling a temperature of the substrate at a time of feeding the plating solution thereto. In this case, the temperature of the substrate can be controlled in such a way that the temperature of the substrate when stopping feeding the plating solution is higher than the temperature of the substrate when starting feeding the plating solution.

The electroless plating method according to the third aspect of the invention can further include feeding a predetermined liquid to the substrate prior to feeding of the plating solution to a top surface thereof; and feeding a predetermined liquid to the substrate after feeding of the plating solution to the top surface thereof.

According to the fourth aspect of the invention, there is provided an electroless plating method which performs electroless plating by supplying a plating solution retained in a plating-solution retaining section to a top surface of a substrate via a plating-solution feeding pipe and a plating-solution discharge nozzle, comprising controlling a temperature of the substrate by adjusting a distance between the substrate and a substrate temperature control member disposed on a bottom side thereof; and feeding the plating solution flowing in the plating-solution feeding pipe to the top surface of the substrate.

In the fourth aspect of the invention, said temperature of said substrate can be controlled in such a way that said temperature of said substrate when stopping feeding said plating solution is higher than said temperature of said substrate when starting feeding said plating solution. The electroless plating method can further include feeding a predetermined liquid to said substrate prior to feeding of said plating solution to a top surface thereof; and feeding a predetermined liquid to said substrate after feeding of said plating solution to said top surface thereof.

According to the fifth aspect of the invention, there is provided a computer readable storage medium storing a control program which allows a computer to control an electroless plating apparatus which performs electroless plating by supplying a plating solution to a top surface of a substrate, wherein said control program, when executed, allows said computer to control said electroless plating apparatus in such a way as to execute an electroless plating method including controlling a temperature of said plating solution flowing in said plating-solution feeding pipe to a predetermined temperature; feeding said temperature-controlled plating solution to said top surface of said substrate; stopping feeding said plating solution to said top surface of said substrate from said plating-solution feeding pipe; and sucking said plating solution in said plating-solution feeding pipe toward said plating-solution retaining section.

According to the sixth aspect of the invention, there is provided a computer readable storage medium storing a control program which allows a computer to control an electroless plating apparatus which performs electroless plating by supplying a plating solution to a top surface of a substrate, wherein said control program, when executed, allows said computer to control said electroless plating apparatus in such a way as to execute an electroless plating method including controlling a temperature of said substrate by adjusting a distance between said substrate and a substrate temperature control member disposed on a bottom side thereof; and feeding said plating solution flowing in said plating-solution feeding pipe to said top surface of said substrate.

According to the invention, a plating solution which flows in the plating-solution feeding pipe and whose temperature is controlled to a predetermined temperature is supplied to the top surface of a substrate, and the plating solution in the plating-solution feeding pipe is sucked toward the plating-solution retaining section when the supply of the plating solution to the top surface of the substrate through the plating-solution feeding pipe is stopped. This configuration can prevent the plating solution from having an undesirable temperature rise, and prevents the plating solution from staying in the plating-solution feeding pipe over a long time. It is therefore possible to always keep the plating solution in use at high quality, so that the quality of the plating of a substrate can be enhanced while suppressing the running cost of the plating solution.

Further, the provision of the substrate temperature control member liftable up and down relative to a substrate on the bottom side of the substrate can ensure finer temperature control and the formation of a plated film with an excellent film quality.

### BRIEF DESCRIPTION OF THE SEVERAL VIEWS OF THE DRAWINGS

FIG. 1 is a plan view showing the schematic configuration of an electroless plating system equipped with an electroless plating unit according to one embodiment of the present invention;

FIG. 2 is a side view showing the schematic configuration of the electroless plating system of FIG. 1;

FIG. 3 is a cross-sectional view showing the schematic configuration of the electroless plating system of FIG. 1;

FIG. 4 is a schematic plan view of the electroless plating unit according to the embodiment of the invention;

FIG. 5 is a schematic cross-sectional view showing the schematic configuration of the electroless plating unit of FIG. 4;

FIG. 6 is a plan view showing the schematic configurations of a nozzle section provided at the electroless plating unit of FIG. 4 and a process-fluid feeding system for feeding a process fluid like a plating solution to the nozzle section;

FIG. 7 is a cross-sectional view showing the schematic configuration of a chemical-solution nozzle provided at the electroless plating unit of FIG. 4;

FIG. 8 is a cross-sectional view showing the schematic configuration of a plating-solution nozzle provided at the electroless plating unit of FIG. 4;

FIGS. 9A to 9C are diagrams for explaining the action of the plating-solution nozzle of FIG. 8 to feed the plating solution;

FIG. 10 is a diagram for explaining an operational mode (moving mode) of the nozzle section provided at the electroless plating unit of FIG. 4;

FIG. 11 is a flowchart schematically illustrating wafer process procedures in the electroless plating system of FIG. 1;

FIG. 12 is a flowchart schematically illustrating wafer process procedures in the electroless plating unit of FIG. 4;

FIG. 13 is a diagram showing another example of an under plate to be used in the electroless plating unit; and

FIG. 14 is a cross-sectional view showing a modification the electroless plating unit.

### DETAILED DESCRIPTION OF THE INVENTION

One embodiment of the present invention will be described below referring to the accompanying drawings.

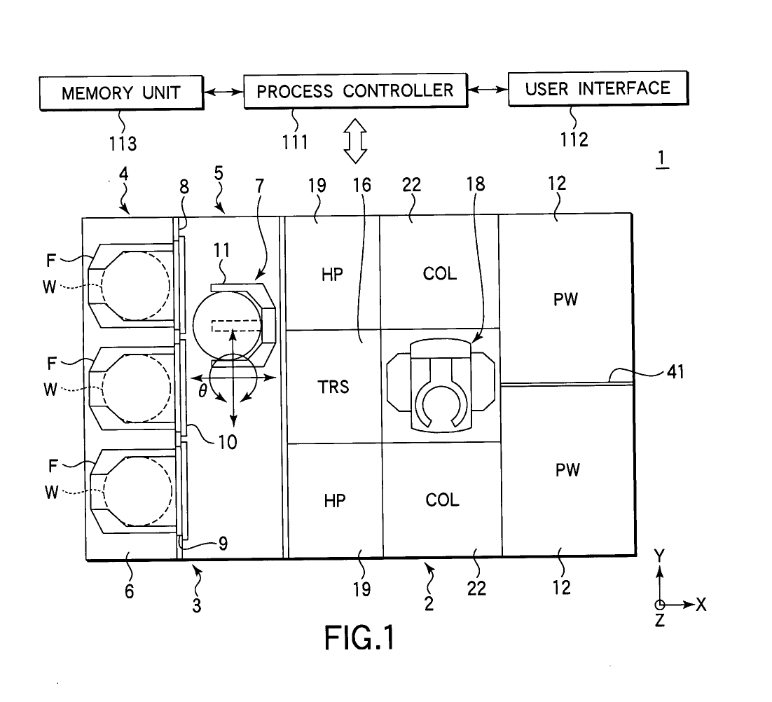

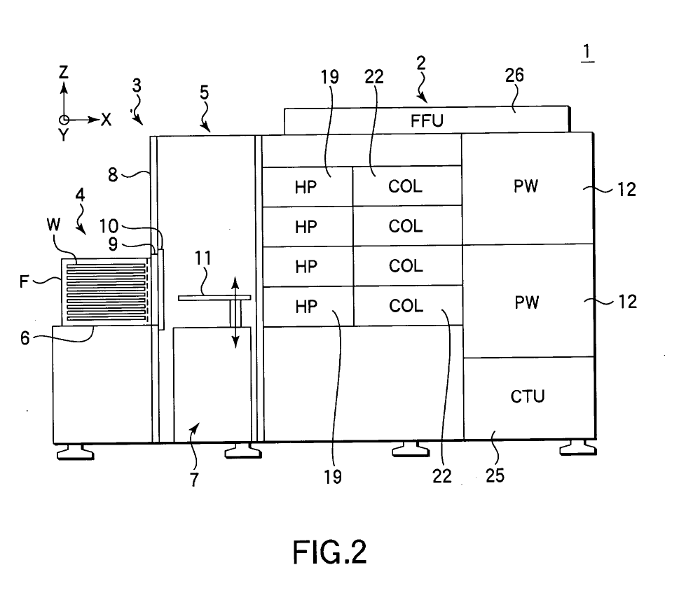

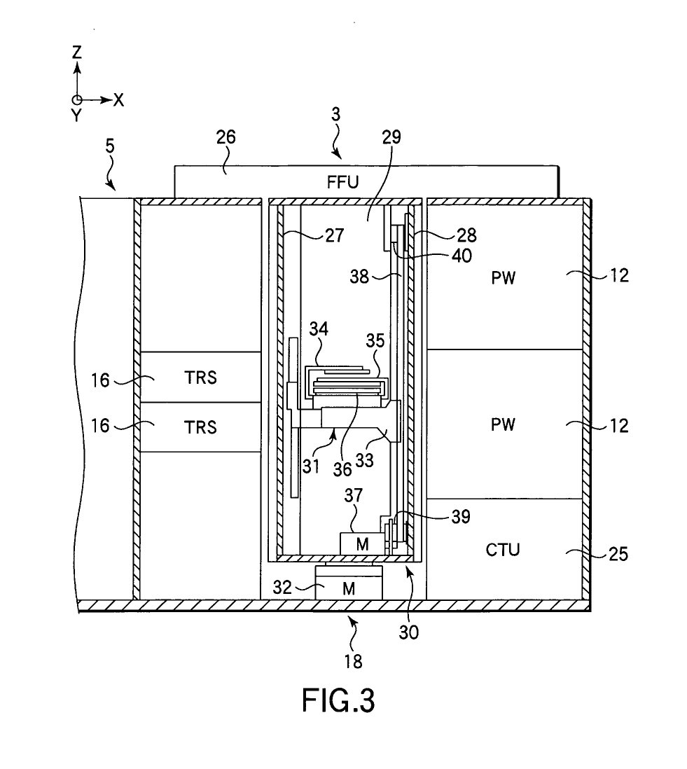

FIG. 1 is a plan view showing the schematic configuration of an electroless plating system equipped with an electroless plating unit according to one embodiment of the invention, FIG. 2 is a side view of the electroless plating system, and FIG. 3 is a cross-sectional view thereof.

An electroless plating system 1 has a processing unit 2 and a transfer in/out unit 3. The processing unit 2 performs an electroless plating process on a semiconductor wafer as a substrate to be processed (hereinafter, simply “wafer”), and a heat treatment of the wafer before and after the electroless plating process. The transfer in/out unit 3 transfers a wafer W into the processing unit 2 and transfers the wafer W out thereof. A wafer W in use has a wiring portion of a metal (not shown) on its top surface. The processing unit 2 performs an electroless plating process on the wiring portion.

The transfer in/out unit 3 includes an in/out port 4 and a wafer transfer section 5. The in/out port 4 is provided with a susceptor 6 on which a FOUP (Front Opening Unified Pod) F, a wafer retaining container, is to be mounted. The wafer transfer section 5 is provided with a wafer transfer mechanism 7 which transfers a wafer W between the FOUP F mounted on the susceptor 6 and the processing unit 2.

The FOUP F can retain multiple (e.g., 25) wafers W vertically stacked one on another in a horizontal state. The FOUP F has a transfer in/out port provided in one side face thereof to carry in/out wafers W, and a lid which can open and close the transfer in/out port. A plurality of slots for retaining wafers W are formed in the FOUP F in the up and down direction. Each slot retains a single wafer W with its top surface (where the wiring portion is formed) up.

The susceptor 6 of the in/out port 4 is structured so that a plurality of FOUPs F, e.g., three FOUPs, are to be mounted thereon in parallel in the widthwise direction (Y direction) of the electroless plating system 1. Each FOUP F is mounted on the susceptor 6 with the side face having the transfer in/out port facing a boundary wall 8 between the in/out port 4 and the wafer transfer section 5. The boundary wall 8 has windows 9 formed at positions corresponding to the mount positions of the FOUPs F and shutters 10 provided on the wafer transfer section 5 side to open/close the respective windows 9.

The shutter 10 can open/close the lid provided at the FOUP F at the same time as opening/closing the window 9. It is preferable that the shutter 10 should be constructed to have an interlock to prevent the shutter 10 from operating when the FOUP F is not mounted on the susceptor 6 at a predetermined position. When the transfer in/out port of the FOUP F communicates with the wafer transfer section 5 with the shutter 10 opening the window 9, the wafer transfer mechanism 7 provided at the wafer transfer section 5 can access the FOUP F. A wafer check mechanism (not shown) is provided at the upper portion of the window 9 so as to be able to detect the number of, and the states of, wafers W retained in the FOUP F slot by slot. Such a wafer check mechanism can be mounted to the shutter 10.

The wafer transfer mechanism 7 provided at the wafer transfer section 5 has a transfer pick 11 to hold a wafer W, and can move in the Y direction. The transfer pick 11 can take a forward/backward motion in the lengthwise direction (X direction) of the electroless plating system 1, lift up/down motion in the height direction (Z direction) of the electroless plating system 1, and a rotational motion within the X-Y plane (θ direction). With this structure, the wafer transfer mechanism 7 can move to a position facing an arbitrary FOUP F mounted on the susceptor 6 to allow the transfer pick 11 to access a slot at an arbitrary height in the FOUP F, and can move to a position facing a wafer transfer unit (TRS) 16 to be discussed later provided at the processing unit 2 to allow the transfer pick 11 to access the wafer transfer unit (TRS) 16. That is, the wafer transfer mechanism 7 is structured so as to transfer a wafer W between each FOUP F and the processing unit 2.

The processing unit 2 includes a wafer transfer unit (TRS) 16, an electroless plating unit (PW) 12, a hot plate unit (HP) 19, a cooling unit (COL) 22, and a main wafer transfer mechanism 18. Wafers W are temporarily mounted on the wafer transfer unit (TRS) 16 for transfer of the wafers W to and from the wafer transfer section 5. The electroless plating unit (PW) 12 performs plating on a wafer W. The hot plate unit (HP) 19 performs a heat treatment on the wafer W before and after the plating process thereon in the electroless plating unit (PW) 12. The cooling unit (COL) 22 cools the wafer W heated by the hot plate unit (HP) 19. The main wafer transfer mechanism 18 transfers wafers W among those units. A fluid retaining unit (CTU) 25 which retains a predetermined fluid, such as a plating solution, to be fed to the electroless plating unit (PW) 12 is provided below the electroless plating unit (PW) 12 of the processing unit 2. The electroless plating apparatus according to the embodiment comprises the electroless plating unit (PW) 12 and a process-fluid feeding mechanism 60 (to be described later) provided at the fluid retaining unit (CTU) 25.

There are two wafer transfer units (TRS) 16 provided which are stacked one on the other between the main wafer transfer mechanism 18, located at nearly the center of the processing unit 2, and the wafer transfer section 5. The lower wafer transfer unit (TRS) 16 is used to mount wafers W which are transferred to the processing unit 2 from the transfer in/out unit 3, and the upper wafer transfer unit (TRS) 16 is used to mount wafers W which are transferred to the transfer in/out unit 3 from the processing unit 2.

There are four hot plate units (HP) 19 stacked one on another on either side of the wafer transfer unit (TRS) 16 in the Y direction thereof. There are four cooling units (COL) 22 stacked one on another on either side of the main wafer transfer mechanism 18 in the Y direction thereof in such a way as to be adjacent to the hot plate units (HP) 19.

There are two stages of electroless plating units (PW) 12, each stage having two electroless plating units (PW) 12 provided side by side in the Y direction, in such a way as to be adjacent to the cooling units (COL) 22 and the main wafer transfer mechanism 18. The electroless plating units (PW) 12 in parallel to each other in the Y direction have approximately the symmetical configuration with respect to a wall surface 41 or the boundary therebetween. The details of the electroless plating unit (PW) 12 will be given later.

The main wafer transfer mechanism 18 includes a cylindrical support 30, which has vertical walls 27, 28 extending in the Z direction and a side opening 29 between the vertical walls 27, 28, and a wafer transfer body 31 provided inside the cylindrical support 30 and liftable up and down in the Z direction along the cylindrical support 30. The cylindrical support 30 is rotatable by the rotational drive force of a motor 32. The wafer transfer body 31 rotates together with the cylindrical support 30.

The wafer transfer body 31 includes a transfer platform 33, and three transfer arms 34, 35, 36 movable forward and backward along the transfer platform 33. The transfer arms 34, 35, 36 are sized so as to be passable through the side opening 29 of the cylindrical support 30. The transfer arms 34, 35, 36 can be independently moved forward and backward by a motor and a belt mechanism, which are incorporated in the transfer platform 33. As a belt 38 is driven by a motor 37, the wafer transfer body 31 moves up and down. Reference numeral “39” denotes a a drive pulley, and reference numeral “40” denotes a driven pulley.

Provided at the ceiling of the processing unit 2 is a filter fan unit (FFU) 26 which effects downflow of clean air to the individual units and the main wafer transfer mechanism 18.

The individual components of the electroless plating system 1 are so configured as to be connected to and controlled by a process controller 111 having a CPU. Connected to the process controller 111 are a user interface 112 and a storage unit 113. The user interface 112 includes a keyboard which a process manager uses to, for example, enter commands to control the individual sections or the individual units of the electroless plating system 1, and a display which presents visual display of the operational statuses of the individual sections or the individual units. Stored in the storage unit 113 are recipes recording control programs and process condition data or so for realizing individual processes to be executed by the electroless plating system 1 under the control of the process controller 111.

As an arbitrary recipe is read from the storage unit 113 and is executed by the process controller 111 in response to an instruction or the like from the user interface 112, as needed, desired processes are executed by the electroless plating system 1 under the control of the process controller 111. The recipes may be those stored in a readable storage medium, such as a CD-ROM, hard disk, a flexible disk or a non-volatile memory, or may be transferred, whenever needed, among the individual sections or the individual units of the electroless plating system 1, or from an external device, and used on line.

Next, the details of the electroless plating unit (PW) 12 will be given.

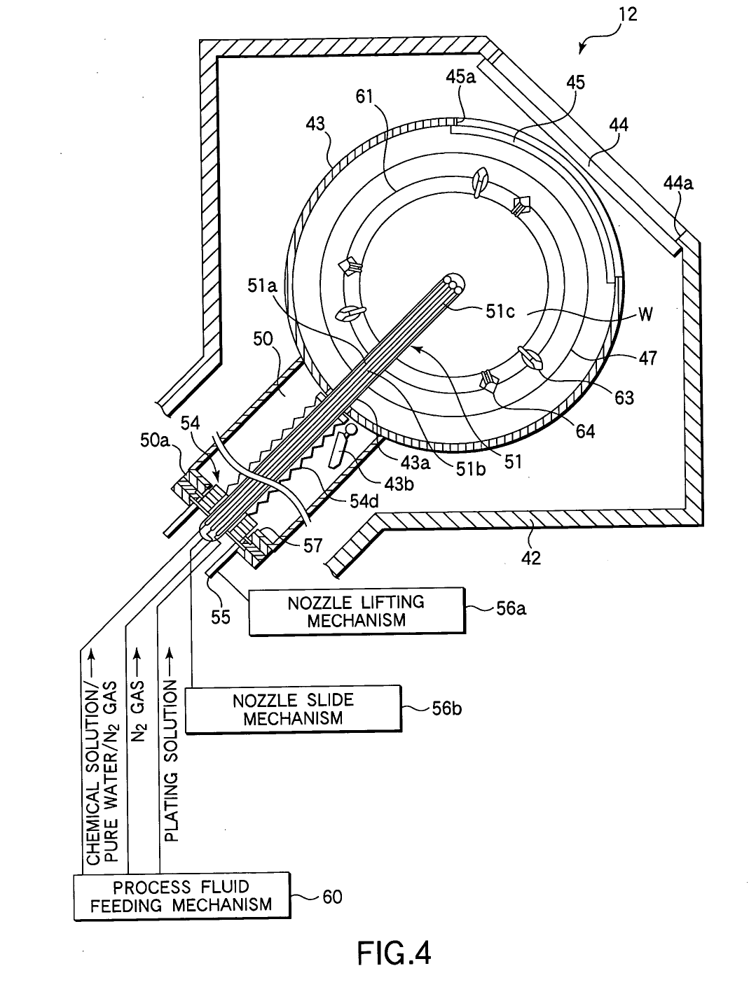

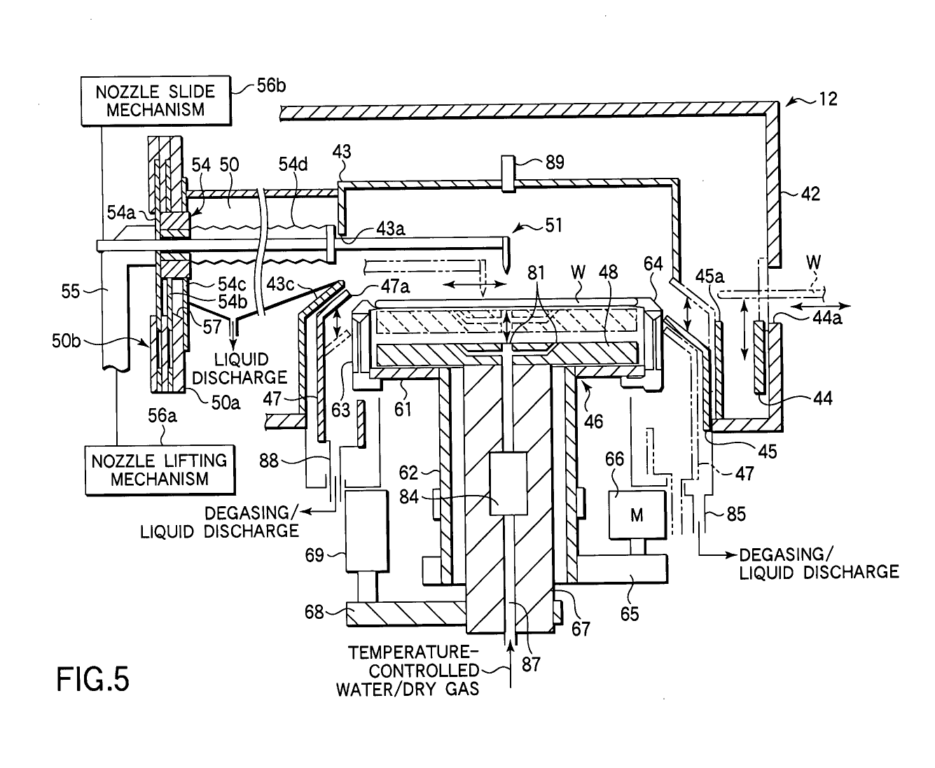

FIG. 4 is a schematic plan view of the electroless plating apparatus (electroless plating unit) 12 according to the embodiment, and FIG. 5 is a schematic cross-sectional view thereof.

The electroless plating unit (PW) 12 includes a housing 42, an outer chamber 43 provided in the housing 42, an inner cup 47 provided in the outer chamber 43, a spin chuck (support) 46 which is provided in the inner cup 47 to support a wafer W, an under plate (substrate temperature control member) 48 for controlling the temperature of a wafer W, and a nozzle section 51 which supplies a liquid, such as a plating solution or a cleaning liquid, and gas onto a wafer W supported by the spin chuck 46. Connected to the nozzle section 51 is the process-fluid feeding mechanism 60 (to be described later) which feeds the plating solution or another fluid provided in the fluid retaining unit (CTU) 25. The spin chuck 46 holds a wafer W with the top surface thereof up. The under plate 48 is provided so as to face the back side (bottom side) of the wafer W supported by the spin chuck 46, and is liftable up and down.

A window 44a is formed in one side wall of the housing 42, and is openable and closable by a first shutter 44. Each of the transfer arms 34, 35, 36 transfers a wafer W to the electroless plating unit (PW) 12 or transfers a wafer W out from the electroless plating unit (PW) 12 through the window 44a. The window 44a is kept closed by the first shutter 44 except at the time of transferring a wafer W in/out. The first shutter 44 opens and closes the window 44a from inside the housing 42.

The outer chamber 43 has a tapered portion 43c at a height where the outer chamber 43 surrounds the wafer W supported by the spin chuck 46. The outer chamber 43 has an inner wall tapered upward from a lower portion. A window 45a is formed in the tapered portion 43c in such a way as to face the window 44a of the housing 42. The window 45a is openable and closable by a second shutter 45. Each of the transfer arms 34, 35, 36 moves into and out of the outer chamber 43 through the window 44a and the window 45a to transfer a wafer W to and from the spin chuck 46. The window 45a is kept closed by the second shutter 45 except at the time of transferring a wafer W in/out. The second shutter 45 opens and closes the window 45a from inside the outer chamber 43.

A gas feeding section 89 which forms a downflow by feeding a nitrogen (N₂) gas into the outer chamber 43 is provided at the top wall of the outer chamber 43. A drain pipe 85 for degasing and liquid discharge is provided at the bottom wall of the outer chamber 43.

The inner cup 47 has a tapered portion 47a, tapered upward from a lower portion, at the upper end portion in such a way as to correspond to the tapered portion 43c of the outer chamber 43, and a drain pipe 88 at the bottom wall. The inner cup 47 is liftable up and down between a process position which is above a wafer W whose upper end is supported by the spin chuck 46 and where the tapered portion 47a surrounds the wafer W (the position indicated by the solid line in FIG. 5), and a retreat position which is below the wafer W whose upper end is supported by the spin chuck 46 (the position indicated by the phantom line in FIG. 5) by a lifting mechanism like a gas cylinder.

The inner cup 47 is held at the retreat position so as not to interfere with the forward/backward movement of each of the transfer arms 34, 35, 36 when each transfer arm 34, 35, 36 transfers a wafer W to and from the spin chuck 46, and is held at the process position when electroless plating is performed on the wafer W supported by the spin chuck 46. This prevents the plating solution supplied to the wafer W from the inner cup 47 from being splashed around. The plating solution that has dropped directly from the wafer W or the plating solution that has spattered on the wafer W and hit the inner cup 47 or the tapered portion 47a of the inner cup 47 is guided down to the drain pipe 88. A plating-solution collect line and a plating-solution dispose line (neither shown) are connected in a changeover manner to the drain pipe 88, so that the plating solution is collected through the plating-solution collect line or is disposed through the plating-solution dispose line.

The spin chuck 46 has a rotary cylinder 62 rotatable in the horizontal direction, an annular rotational plate 61 rotary cylinder 62 extending horizontally from the upper end portion of the rotary cylinder 62, mount pins 63 which are provided at the peripheral portion of the rotational plate 61 to support a wafer W mounted on the mount pins 63, and press pins 64 which are provided at the peripheral portion of the rotational plate 61 to support a wafer W mounted on the mount pins 63 by pressing the edge portion of the supported wafer W.

Transfer of a wafer W between each transfer arm 34, 35, 36 and the spin chuck 46 is executed by using the mount pins 63. To surely support a wafer W, it is preferable that the mount pins 63 should be provided at at least three locations, preferably at equal intervals.

The press pin 64 is structured so that as the portion positioned at the lower portion of the rotational plate 61 is pressed against the rotational plate 61 by a pressing mechanism (not shown), the upper end portion (distal end portion) of the press pin 64 can move outward of the rotational plate 61 and incline so as not to interfere with the transfer of a wafer W between each of the transfer arms 34, 35, 36 and the spin chuck 46. To surely support a wafer W, the mount pins 63 should likewise be provided at at least three locations, preferably at equal intervals.

A belt 65 which rotates when a motor 66 is driven is put around the outer surface of the rotary cylinder 62. Accordingly, the rotary cylinder 62 rotates, causing the wafer W supported by the mount pins 63 and the press pins 64 to rotate horizontally. As the position of the barycenter of the press pin 64 is adjusted, the force of pressing a wafer W is adjusted when the wafer W rotates. For example, providing the barycenter of the press pin 64 lower than the rotational plate 61 causes the centrifugal force to act on the portion lower than the rotational plate 61 so that the upper end portion of the press pin 64 tends to move inward, thus enhancing the force to press the wafer W.

The under plate 48 is disposed above the rotational plate 61 and in the space surrounded by the mount pins 63 and the press pins 64, and is connected to a shaft 67 provided penetrating through inside the rotary cylinder 62. The shaft 67 connected with the under plate 48 is connected to a lifting mechanism 69 like an air cylinder via a horizontal plate 68 provided below the rotary cylinder 62. The lifting mechanism 69 allows the shaft 67 to be liftable up and down together with the under plate 48. A plurality of process-fluid feeding ports 81 through which a process fluid, such as pure water or a dry gas, is supplied toward the bottom side of a wafer W are provided at the top surface of the under plate 48. A process-fluid feeding path 87 along which the process fluid, such as pure water or a dry gas, flows to the process-fluid feeding ports 81 is provided in the under plate 48 and the shaft 67. A heat exchanger 84 is provided around a part of the process-fluid feeding path 87 in the shaft 67, so that the process fluid flowing in the process-fluid feeding path 87 is heated to a predetermined temperature by the heat exchanger 84 and is then supplied toward the bottom side of the wafer W from the process-fluid feeding ports 81.

When a wafer W is transferred between the spin chuck 46 and each transfer arm 34, 35, 36, the under plate 48 moves downward to come close to the rotational plate 61 so as not to hit against each transfer arm 34, 35, 36. When electroless plating is performed on the wafer W supported by the spin chuck 46, the under plate 48 moves upward to the position of the phantom line in FIG. 5 close to the wafer W to feed the temperature-controlled fluid, such as pure water, whose predetermined is controlled to a predetermined temperature, to the bottom side of the wafer W from the process-fluid feeding ports 81, thereby heating the wafer W and controlling the temperature thereof to a predetermined temperature.

A nozzle-section storing chamber 50 is provided at one side wall of the outer chamber 43 to communicate therewith. The nozzle section 51 extends horizontally and is fitted into the nozzle-section storing chamber 50. The nozzle section 51 is liftable up and down by a nozzle lifting mechanism 56a and is slidable by a nozzle slide mechanism 56b. The nozzle slide mechanism 56b causes the nozzle section 51 to slide so that in a process mode, the distal end portion of the nozzle section 51 (the side which ejects the plating solution or the like onto a wafer W) sticks out from the nozzle-section storing chamber 50 and reaches a position above the wafer W in the outer chamber 43, while, in a temperature control mode, the distal end portion of the nozzle section 51 is retained in the nozzle-section storing chamber 50 as will be discussed later. The nozzle section 51 integrally has a chemical-solution nozzle 51a capable of feeding a chemical solution, pure water and nitrogen gas onto a wafer W, a dry nozzle 51b capable of feeding a nitrogen gas as a dry gas onto a wafer W, and a plating-solution nozzle 51c capable of feeding a plating solution onto a wafer W.

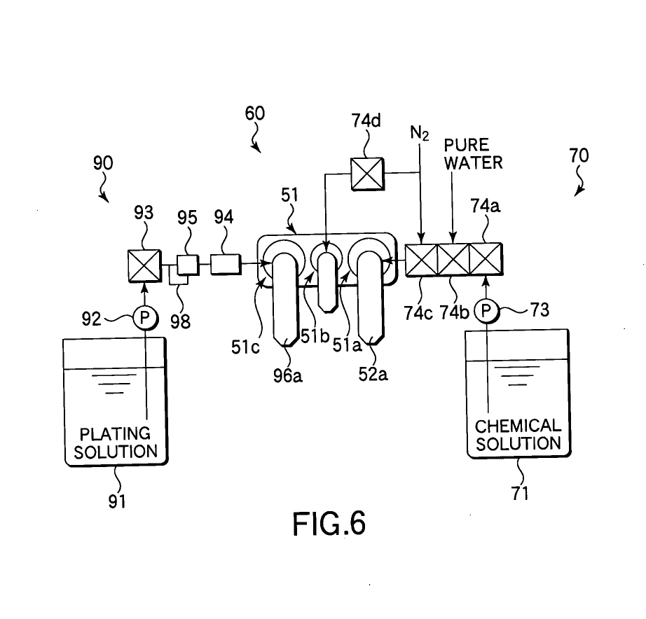

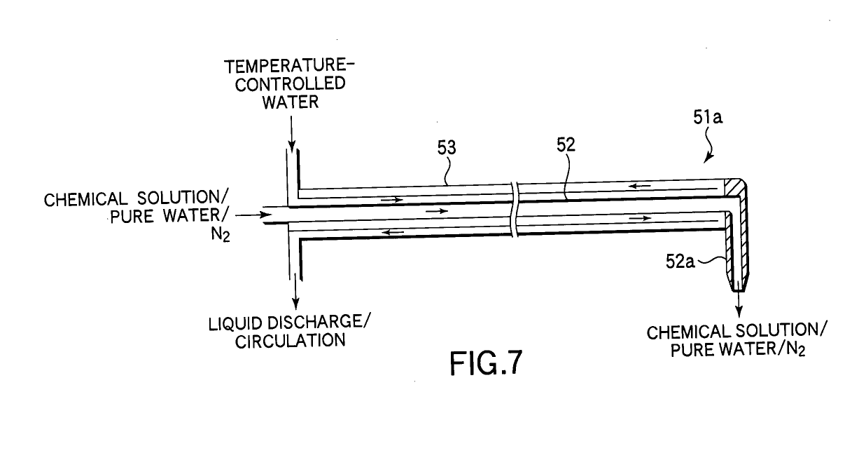

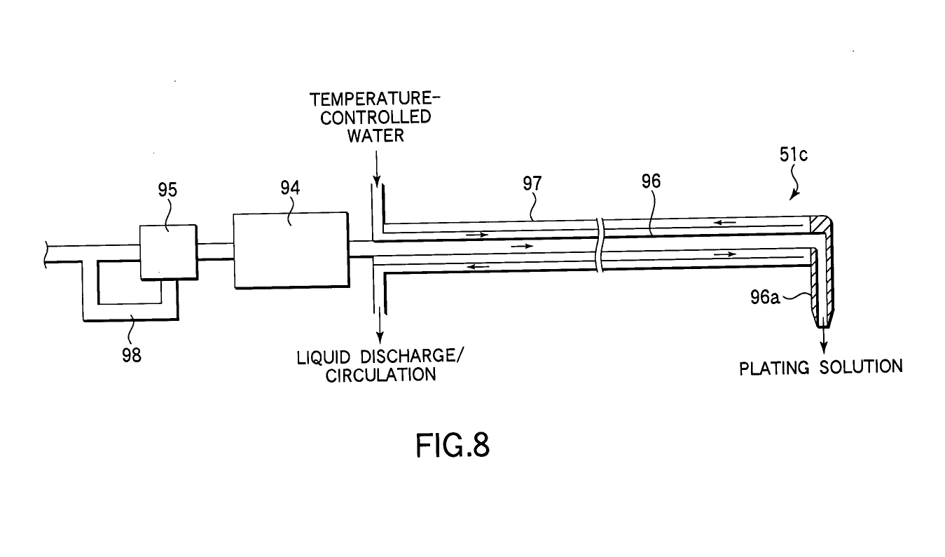

The process-fluid feeding mechanism 60 will be explained next. FIG. 6 is a diagram showing the schematic configuration of the process-fluid feeding mechanism 60, FIG. 7 is a cross-sectional view showing the schematic configuration of the chemical-solution nozzle 51a, and FIG. 8 is a cross-sectional view showing the schematic configuration of a plating-solution nozzle 51c.

As shown in FIG. 6, the process-fluid feeding mechanism 60 has a chemical-solution feeding mechanism 70 for feeding a chemical solution or the like to the chemical-solution nozzle 51a, and a plating-solution feeding mechanism 90 for feeding a plating solution to the plating-solution nozzle 51c.

The chemical-solution feeding mechanism 70 has a chemical-solution tank 71, a pump 73, and a valve 74a, all disposed in the fluid retaining unit (CTU) 25. The chemical-solution tank 71 heats the chemical solution to a predetermined temperature and retains the chemical solution. The pump 73 pumps up the chemical solution in the chemical-solution tank 71. The valve 74a changes over the chemical solution pumped up by the pump 73 to feed the chemical solution to the chemical-solution nozzle 51a. In addition to the chemical solution fed by the chemical-solution feeding mechanism 70, pure water and a nitrogen gas whose temperatures are controlled to predetermined temperatures are to be supplied to the chemical-solution nozzle 51a. One of the chemical solution, pure water and nitrogen gas is selectively fed by changing the opening/closing of the valves 74a, 74b, 74c. The same nitrogen-gas source can be used for the nitrogen gas to be fed to the chemical-solution nozzle 51a and the dry nozzle 51b, and feeding of the nitrogen gas to the dry nozzle 51b can be controlled by the opening/closing of a valve 74d provided separately.

The plating-solution feeding mechanism 90 has a plating-solution tank (plating-solution retaining section) 91, a pump 92, a valve 93, a heat source 94, and a suction mechanism 95, all disposed in the fluid retaining unit (CTU) 25. The plating-solution tank 91 retains the chemical solution. The pump 92 pumps up the plating solution in the plating-solution tank 91. The valve 93 changes over the plating solution pumped up by the pump 92 to feed the plating solution to the plating-solution nozzle 51c. The heat source 94 heats the plating solution to be fed through the valve 93 to the plating-solution nozzle 51c to a predetermined temperature. The suction mechanism 95 sucks the plating solution fed to the plating-solution nozzle 51c when feeding of the plating solution onto a wafer W from the plating-solution nozzle 51c is stopped. The heat source 94 comprises a heater or a a heat exchanger or the like. The suction mechanism 95 comprises an aspirator, pump, etc.

As shown in FIG. 7, the chemical-solution nozzle 51a has a chemical-solution feeding pipe 52 which feeds a chemical solution or so fed from the chemical-solution feeding mechanism 70 onto a wafer W, and a chemical-solution temperature control pipe 53 so provided as to surround the chemical-solution feeding pipe 52. The chemical-solution temperature control pipe 53 covers nearly the entire chemical-solution feeding pipe 52 in the lengthwise direction thereof. A nozzle chip 52a which ejects a chemical solution or so downward over the wafer W is provided at the distal end portion of the chemical-solution feeding pipe 52.

The chemical-solution temperature control pipe 53 serves to suppress a change in the temperature or a temperature drop of a chemical solution or the like flowing in the chemical-solution feeding pipe 52 as a temperature-controlled fluid, e.g., temperature-controlled water, heated to a predetermined temperature, flows inside the chemical-solution temperature control pipe 53. Accordingly, a process which maximizes the performance of the chemical solution is executed. The chemical-solution temperature control pipe 53 has a double-pipe structure having an inner pipe and an outer pipe, so that the temperature-controlled fluid having flowed in the inner pipe flows back at the distal end portion, and flows in the outer pipe. This can stabilize the temperature of the temperature-controlled water flowing inside the chemical-solution temperature control pipe 53.

As shown in FIG. 8, the plating-solution nozzle 51c has a plating-solution feeding pipe 96 which guides the plating solution fed from the plating-solution feeding mechanism 90 onto a wafer W, and a plating-solution temperature control pipe 97 so provided as to surround the plating-solution feeding pipe 96. The plating-solution temperature control pipe 97 covers nearly the entire distal end side of the. The plating-solution feeding pipe 96 protrudes upstream of the plating-solution temperature control pipe 97 (the connection side to the plating-solution tank 91). A nozzle chip 96a which ejects the chemical solution downward over the wafer W is provided at the distal end portion of the plating-solution feeding pipe 96.

The plating-solution temperature control pipe 97 serves to suppress a change in the temperature or a temperature drop of a plating solution flowing in the plating-solution feeding pipe 96 as a temperature-controlled fluid, e.g., temperature-controlled water, heated to a predetermined temperature, flows inside the plating-solution temperature control pipe 97. Accordingly, a plating process which maximizes the performance of the plating solution is executed, thereby enhancing the film quality of the plated film. The plating-solution temperature control pipe 97, like the chemical-solution temperature control pipe 53, has a double-pipe structure having an inner pipe and an outer pipe, so that the temperature-controlled fluid having flowed in the inner pipe flows back at the distal end portion, and flows in the outer pipe. This can stabilize the temperature of the temperature-controlled water flowing inside the plating-solution temperature control pipe 97.

The plating-solution temperature control pipe 97 and the chemical-solution temperature control pipe 53 may be configured so that the temperature-controlled water having flowed in the outer pipe flows back at the distal end portion thereof, and flows in the inner pipe. The temperature-controlled water which flows in the plating-solution temperature control pipe 97 and the chemical-solution temperature control pipe 53 may be recirculated, or may be disposed after passing the pipes. It is preferable to provide a heat insulator, such as glass wool, around the plating-solution temperature control pipe 97 and the chemical-solution temperature control pipe 53, thereby enhancing the heat insulation of the plating-solution temperature control pipe 97 and the chemical-solution temperature control pipe 53.

The heat source 94 is provided on the upstream side of the plating-solution feeding pipe 96 sticking out more than the plating-solution temperature control pipe 97. The suction mechanism 95 is provided on a further upstream side of the plating-solution feeding pipe 96 than the heat source 94. It is preferable that the heat source 94 should be formed of a material with high heat conductivity. The heat source 94 and the plating-solution temperature control pipe 97 constitute a plating-solution temperature controlling mechanism for controlling the temperature of the plating solution which flows inside the plating-solution feeding pipe 96. The plating-solution temperature controlling mechanism works so that a temperature control system (not shown) controls the plating solution to a set temperature. To heat the plating solution at a normal temperature to, for example, 60 to 80° C., the heat exchanger in the heat source 94 or in the plating-solution temperature controlling mechanism should have a sufficient length. The plating solution warmed by the heat source 94 is kept warm until the plating solution is discharged from the nozzle chip 96a by the plating-solution temperature control pipe 97.

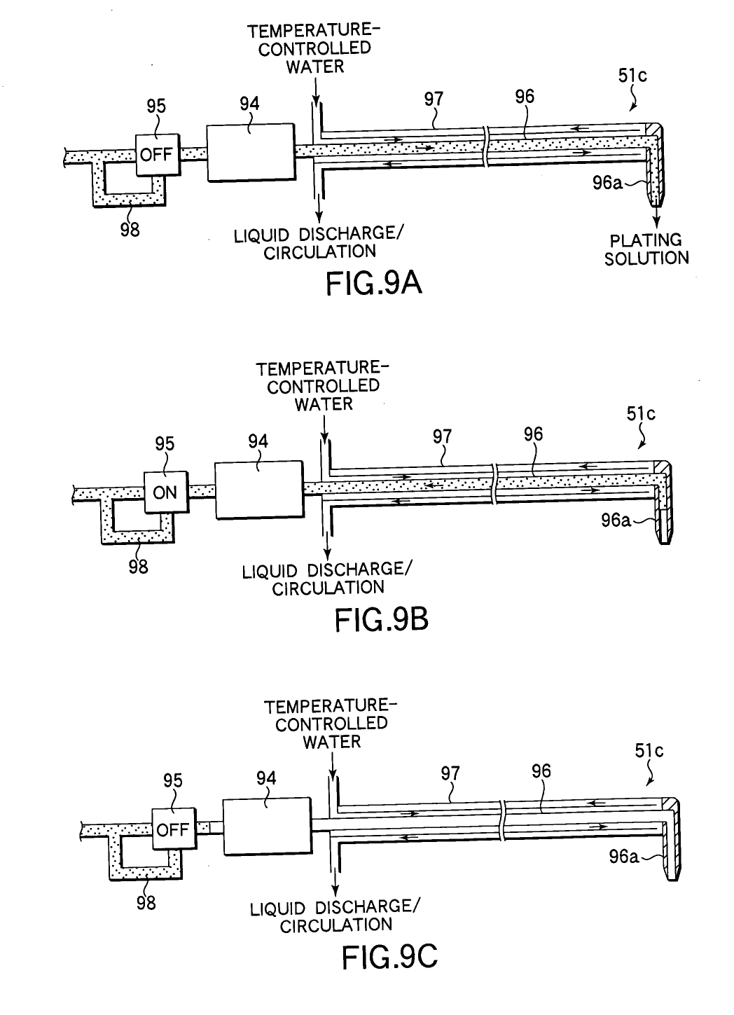

FIGS. 9A to 9C are diagrams for explaining the action of the plating-solution nozzle 51c to feed the plating solution. The suction mechanism 95 is configured in such a way that the suction mechanism 95 is stopped when the plating solution is supplied to a wafer W from the plating-solution nozzle 51c as shown in FIG. 9A, is activated when the supply of the plating solution to a wafer W from the plating-solution nozzle 51c is stopped as shown in FIG. 9B, and sucks the plating solution in the plating-solution feeding pipe 96 toward the plating-solution tank 91 until the plating solution passes at least the heat source 94 as shown in FIG. 9C. The plating solution sucked by the suction mechanism 95 is fed into a branch pipe 98, connected to the plating-solution feeding pipe 96, to be returned to the upstream side in the plating-solution feeding pipe 96. This configuration can suppress deterioration of the plating solution before use as well as can suppress the use amount of the plating solution smaller.

The nozzle section 51 is held by an annular nozzle holding member 54 provided at a wall portion 50a constituting the outer wall of the nozzle-section storing chamber 50. The nozzle holding member 54 is so provided as to close an insertion hole 57 formed in the wall portion 50a and to be slidable in the up and down direction. The nozzle holding member 54 has three plate-like members 54a, 54b, 54c at predetermined intervals therebetween. An engage portion 50b which tightly engages with the plate-like members 54a, 54b, 54c in the thickness direction is formed at the edge portion of the insertion hole 57 of the wall portion 50a. As the tight engagement of the plate-like members 54a, 54b, 54c with the engage portion 50b makes the atmosphere in the nozzle-section storing chamber 50 hard to leak outside.

The nozzle lifting mechanism 56a is connected to the nozzle holding member 54 outside the nozzle-section storing chamber 50 via an approximately L-shaped arm 55. The nozzle lifting mechanism 56a causes the nozzle section 51 to lift up and down via the nozzle holding member 54. A cornice-like stretch portion 54d which surrounds the nozzle section 51 is provided at the nozzle holding member 54 inside the nozzle-section storing chamber 50. The nozzle section 51 is movable horizontally by the nozzle slide mechanism 56b, and the stretch portion 54d stretches and contracts according to the sliding of the nozzle section 51.

A window 43a through which the nozzle section 51 moves in and out is provided at the boundary wall portion between the nozzle-section storing chamber 50 and the outer chamber 43. The window 43a can be opened and closed by a door mechanism 43b. With the window 43a open, when the nozzle section 51 comes to a height corresponding to the window 43a by the nozzle lifting mechanism 56a, the distal-end side portion of the nozzle section 51 can move in and out of the outer chamber 43 by the nozzle slide mechanism 56b.

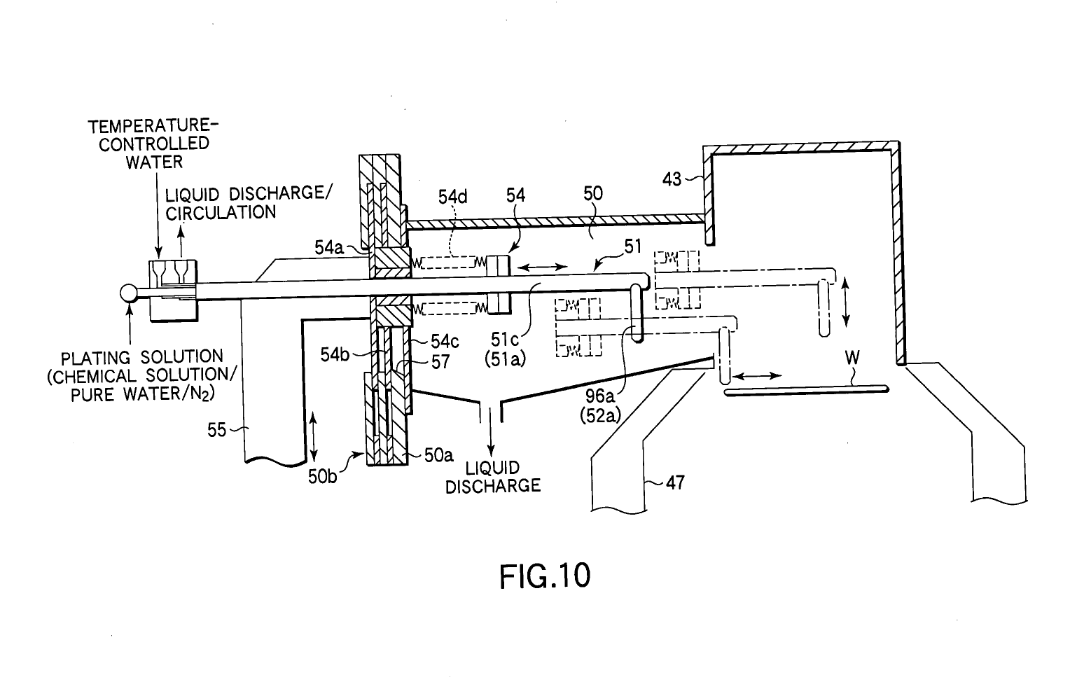

As shown in FIG. 10, the distal-end side portion of the nozzle section 51 is stored in the nozzle-section storing chamber 50 (see the solid line) with the nozzle section 51 being at a maximum retreat position, and the nozzle chip 96a, 52a is placed approximately in the center of the wafer W (see the phantom line) with the nozzle section 51 being at a maximum advance position. With the nozzle chip 96a, 52a being placed in the inner cup 47, as the nozzle section 51 is lifted up and down by the nozzle lifting mechanism 56a, the distances between the distal end of the nozzle chip 96a, 52a and the wafer W is adjusted, and as the nozzle chip 96a, 52a linearly slides between the approximate center of the wafer W and the periphery thereof by the nozzle slide mechanism 56b, the plating solution or the like can be fed to a desired radial position of the wafer W.

It is preferable that the top surface of the nozzle section 51 should be coated with a resin excellent in corrosion resistance against an acidic chemical solution and an alkaline plating solution which are used in cleaning wafers W, e.g., a fluororesin. It is also preferable that such coating is done on various components, such as the inner wall of the nozzle-section storing chamber 50, the inner wall of the outer chamber 43, and the under plate 48 disposed in the outer chamber 43. It is preferable that the nozzle-section storing chamber 50 should be provided with a cleaning mechanism to clean the distal end portion of the nozzle section 51.

In the electroless plating system 1, the pressure inside the clean room where the wafer transfer unit (TRS) 16 and the main wafer transfer mechanism 18 are provided is kept positive more than the pressure in the electroless plating unit (PW) 12, and the pressures inside the hot plate unit (HP) 19 and the cooling unit (COL) 22 are kept positive more than the pressure in the clean room. This prevents the atmosphere and particles in the electroless plating unit (PW) 12 from flowing into the clean room, prevents the atmosphere and particles in the clean room from flowing into the hot plate unit (HP) 19 and the cooling unit (COL) 22.

Next, procedures of processing a wafer W in the electroless plating system 1 will be explained.

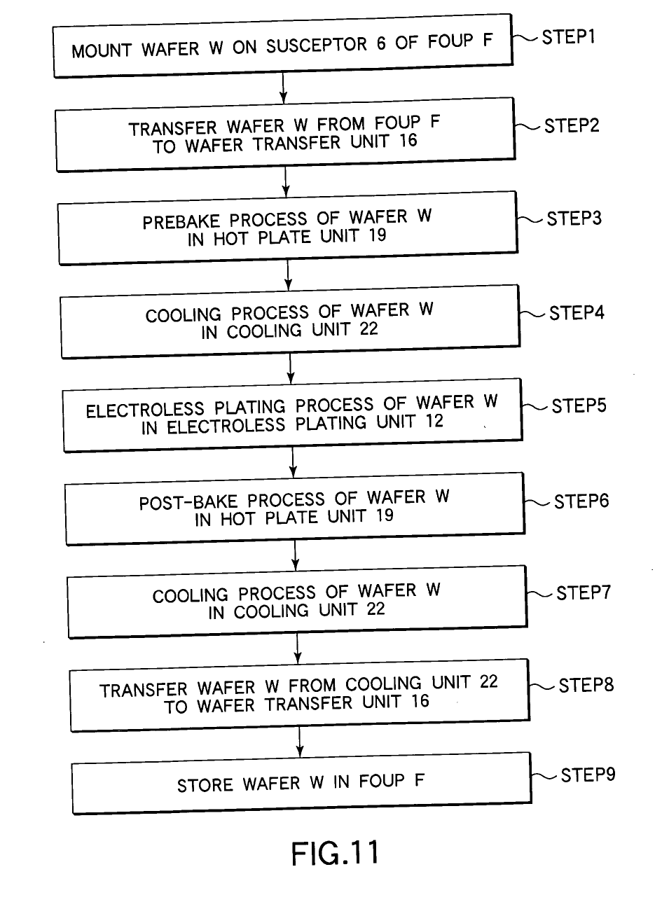

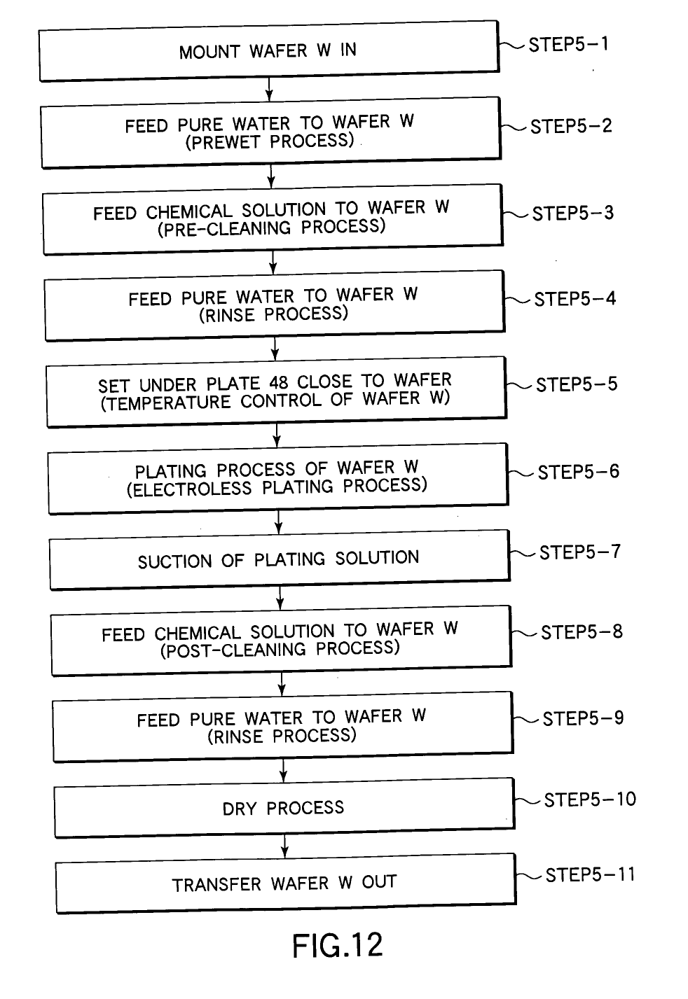

FIG. 11 is a flowchart schematically illustrating wafer process procedures in the electroless plating system 1, and FIG. 12 is a flowchart schematically illustrating wafer process procedures in the electroless plating unit 12.

First, a FOUP F retaining unprocessed wafers W is mounted on the susceptor 6 of the in/out port 4 at a predetermined position by a transfer robot, an operator, etc. (step 1). Next, the transfer pick 11 picks up the wafers W from the FOUP F one by one, and transfers the picked-up wafer W to one of the two wafer transfer units (TRS) 16 (step 2).

The wafer W transferred onto the wafer transfer unit (TRS) 16 by the transfer pick 11 is transferred to one of the multiple hot plate units (HP) 19 by one of the transfer arms 34 to 36 of the main wafer transfer mechanism 18. The wafer W is pre-baked in the hot plate unit (HP) 19 (step 3), resulting in sublimation of an organic film provided on the wafer W to prevent corrosion of the Cu wires. Then, the main wafer transfer mechanism 18 transfers the wafer W in the hot plate unit (HP) 19 to one of the multiple cooling units (COL) 22 where the wafer W is subjected to a cooling process (step 4).

When the cooling process of the wafer W in the cooling unit (COL) 22 is completed, the main wafer transfer mechanism 18 transfers the wafer W to one of the multiple electroless plating units (PW) 12 where the wafer W is subjected to a plating process (step 5). The detailed procedures will be described later.

When the electroless plating process of the wafer W in the electroless plating unit (PW) 12 is completed, the main wafer transfer mechanism 18 transfers the wafer W to the hot plate unit (HP) 19 where the wafer W is post-baked (step 6). This results in sublimation of an organic substance contained in the plated film coated on the wiring portion on the wafer W and enhances the adhesion between the wiring portion on the wafer W and the plated film. Then, the main wafer transfer mechanism 18 transfers the wafer W in the hot plate unit (HP) 19 to the cooling unit (COL) 22 where the wafer W is subjected to a cooling process (step 7).

When the cooling process of the wafer W in the cooling unit (COL) 22 is completed, the main wafer transfer mechanism 18 transfers the wafer W to the wafer transfer unit (TRS) 16 (step 8). Then, the transfer pick 11 picks up the wafer W placed on the wafer transfer unit (TRS) 16, and returns the wafer W into the original slot of the FOUP F where the wafer W has been originally retained (step 9).

A detailed description will now be given of the procedures of the plating process of the wafer W in the electroless plating unit (PW) 12 in the step 5.

First, the wafer W transferred from the cooling unit (COL) 22 by the main wafer transfer mechanism 18 is placed into the electroless plating unit (PW) 12 (step 5-1). At this time, the first shutter 44 provided at the housing 42 and the second shutter 45 provided at the outer chamber 43 are opened to open the windows 44a and 45a, the inner cup 47 is moved down to the retreat position, and the under plate 48 is moved down to a position close to the rotational plate 61. In this state, one of the transfer arms 34, 35, 36 of the main wafer transfer mechanism 18 is moved into the outer chamber 43 to transfer the wafer W to the mount pins 63 provided at the spin chuck 46, and the wafer W is supported by the press pins 64. Thereafter, the transfer arm is moved out of the outer chamber 43, and the first shutter 44 and the second shutter 45 close the windows 44a and 45a.

It is preferable that before this series of operations is finished, temperature-controlled water should circulate into the chemical-solution temperature control pipe 53 of the chemical-solution nozzle 51a and the plating-solution temperature control pipe 97 of the plating-solution nozzle 51c to adjust the temperatures of the chemical-solution nozzle 51a and the plating-solution nozzle 51c.

Next, the window 43a is opened, and the distal-end side portion of the nozzle section 51 enters the outer chamber 43 to be positioned over the wafer W. Then, pure water is supplied onto the wafer W by the chemical-solution nozzle 51a to perform a pre-wet process of the wafer W (step 5-2). The pre-wet process of the wafer W is carried out by moving the nozzle section 51 in such a way as to, for example, form a paddle of a process liquid or pure water in this case on the wafer W while the wafer W is stationary or rotating at a gentle rotational speed, and linearly scan the nozzle chip 52a of the chemical-solution nozzle 51a between the center portion of the wafer W and the peripheral portion thereof while ejecting a predetermined amount of pure water to the wafer W from the nozzle section 51, the chemical-solution nozzle 51a in this case, with the wafer W held over a predetermined time or rotating at a given rotational speed. A cleaning process, a rinse process, an electroless plating process and a dry process of the wafer W to be described later can likewise be carried out by such a method. The number of rotations of the wafer W is adequately selected according to the process conditions of the cleaning process, the electroless plating process and the like.

When the pre-wet process of the wafer W is finished and the pure water adhered to the wafer W is spun off to some degree by the rotation of the spin chuck 46, a chemical solution from the chemical-solution tank 71 is fed onto the wafer W by the nozzle section 51 to perform a pre-cleaning process of the wafer W (step 5-3). This removes the acidic film adhered to the wiring portion of the wafer W. The chemical solution spun off or dropped off the wafer W is discharged from the drain pipe 85 to be used again or disposed.

When the pre-cleaning process of the wafer W is finished, pure water is supplied onto the wafer W by the chemical-solution nozzle 51a to perform a rinse process of the wafer W (step 5-4). During or after the rinse process of the wafer W, the under plate 48 is moved up to come close to the wafer W, pure ware heated to a predetermined temperature is supplied from the process-fluid feeding ports 81 for temperature control to heat the wafer W to that temperature (step 5-5). It is desirable to identically set the temperatures of pure waters supplied to from the under plate 48 and the process-fluid feeding ports 81 and the temperatures of the temperature-controlled waters flowing in the heat source 94 and the plating-solution temperature control pipe 97. This is because the plating reaction is sensitive to temperature so that poor uniformness of the temperature in the wafer surface directly affects the thickness of the deposited plated film in the electroless plating process to be described later.

When the rinse process of the wafer W is finished and the pure water adhered to the wafer W is spun off to some degree by the rotation of the spin chuck 46, the inner cup 47 is moved up to the process position. Then, the plating-solution nozzle 51c feeds the plating solution from the plating-solution tank 91 onto the wafer W, heated and undergone temperature control by the under plate 48, to perform the electroless plating process of the wafer W (step 5-6).

In the electroless plating process, starting the plating process during heating of the wafer W to a predetermined temperature tends to make the morphology of the deposited plated film better than starting the plating process after heating the wafer W to the predetermined temperature. It is therefore preferable that the timing to feed the plating solution to the wafer W from the plating-solution nozzle 51c should be after the temperature of the wafer W starts rising but before it reaches the predetermined temperature. In other words, it is preferable that the temperature of the wafer W should be higher when the supply of the plating solution ends than when the supply of the plating solution starts.

At the time of performing the electroless plating process, the plating solution flowing in the plating-solution feeding pipe 96 can be kept at a predetermined temperature by the temperature-controlled water flowing in the plating-solution temperature control pipe 97 of the plating-solution nozzle 51c. This can prevent the temperature of the plating solution to be supplied onto the wafer W from dropping, and allow electroless plating to be performed on the wiring portion of the wafer W with the plating solution having a predetermined temperature, e.g., 60 to 80° C. At the time of performing the cleaning process, likewise, the temperature of the chemical solution flowing in the chemical-solution feeding pipe 52 can be kept at a predetermined temperature by the temperature-controlled water flowing in the chemical-solution temperature control pipe 53 of the chemical-solution nozzle 51a, preventing the temperature of the chemical solution to be supplied onto the wafer W from dropping, so that the wafer W can be cleaned with the chemical solution having a predetermined temperature.

When the supply of the plating solution onto the wafer W from the plating-solution nozzle 51c ends, the plating solution in the plating-solution nozzle 51c is sucked and returned to the plating-solution tank 91 by the suction mechanism 95 (step 5-7). Specifically, as shown in FIGS. 9B and 9C, the suction mechanism 95 is set ON to suck the plating solution flowing in the plating-solution feeding pipe 96 toward the plating-solution tank 91 until the plating solution passes at least the heat source 94, and is then set OFF. This prevents the plating solution flowing in the plating-solution feeding pipe 96 from being kept heated more than necessary, so that a deteriorated plating solution in the plating-solution feeding pipe 96 is not likely to be supplied onto the wafer W. In addition, it is unnecessary to dispose the deteriorated plating solution in the plating-solution feeding pipe 96 before feeding the plating solution to the wafer W, suppressing the deterioration of the plating solution and improving the running cost of the plating solution.

When the electroless plating process of the wafer W is finished, the supply of heated pure water from the process-fluid feeding ports 81 of the under plate 48 is stopped and the inner cup 47 is moved down to the retreat position. Then, the chemical-solution nozzle 51a feeds the chemical solution from the chemical-solution tank 71 onto the wafer W to perform a post-cleaning process of the wafer W (step 5-8). This eliminates the residue of the plating solution adhered on the wafer W, thus preventing contamination. The chemical solution spun off or dropped off the wafer W is discharged from the drain pipe 85 to be used again or disposed.

When the post-cleaning process of the wafer W is finished, the chemical-solution nozzle 51a feeds pure water onto the wafer W to perform a rinse process of the wafer W (step 5-9). At the time of the rinse process, the chemical solution remaining in the chemical-solution nozzle 51a is ejected first and the internal cleaning of the chemical-solution nozzle 51a is executed at the same time. The chemical-solution nozzle 51a and the chemical-solution feeding mechanism 70 constitute the postprocess-liquid feeding mechanism which feeds a chemical solution and pure water onto a wafer W after the electroless plating process.

In the rinse process, procedures of temporarily stopping feeding pure water from the chemical-solution nozzle 51a and rotating the wafer W at a high rotational speed to remove pure water off the wafer W once, then setting the rotational speed of the wafer W back and feeding pure water onto the wafer W again may be repeated. The rinse process may be carried out with temperature-controlled water flowing in the chemical-solution temperature control pipe 53 or after the flow of the temperature-controlled water is stopped.

At the time of or after the rinse process, the under plate 48 is moved downward away from the wafer W. When the rinse process is completely finished, the wafer W is rotated by the spin chuck 46 and a nitrogen gas is fed onto the wafer W from the chemical-solution nozzle 51a to perform a dry process of the wafer W (step 5-10). When the nitrogen gas is fed onto the wafer W from the chemical-solution nozzle 51a, pure water remaining in the chemical-solution nozzle 51a is ejected onto the wafer W first. Because the film of pure water remains on the wafer W, however, the pure water if mixed into the fed nitrogen gas does not produce water marks on the top surface of the wafer W.

At the time of the dry process, the nitrogen gas is fed to the bottom side of the wafer W from the process-fluid feeding ports 81 of the under plate 48, and the under plate 48 is moved upward again to come close to the wafer W and dry the bottom side of the wafer W. The reason why the under plate 48 is moved downward first and then moved upward again is to prevent pure water remaining in the process-fluid feeding path 87 from being ejected to wet the bottom side of the wafer W by a change in pressure caused by the rotation of the wafer W, and to prevent pure water remaining in the process-fluid feeding path 87 from being abruptly ejected, damaging the wafer W, when the nitrogen gas is fed to the bottom side of the wafer W from the process-fluid feeding ports 81. What is more, this particular movement of the under plate 48 prevents the generation of water marks on the bottom side of the wafer W.

The dry process of the wafer W can be carried out by, for example, rotating the wafer W at a low rotational speed for a predetermined time, then rotating the wafer W at a high rotational speed for a predetermined time.

When the dry process of the wafer W is finished, the wafer W is transferred out of the electroless plating unit (PW) 12 (step 5-11). Specifically, first, the nozzle section 51 is moved to a predetermined height by the nozzle lifting mechanism 56a as needed, the distal end portion of the nozzle section 51 is stored in the nozzle-section storing chamber 50 by the nozzle slide mechanism 56b, and the window 43a is closed. Next, the under plate 48 is moved downward away from the wafer W in which state the wafer W is relieved of the pressure of the press pins 64 and is supported only by the mount pins 63. Next, the windows 44a and 45a are opened, and one of the transfer arms 34, 35, 36 enters the outer chamber 43 to receive the wafer W supported by the mount pins 63. Then, the transfer arm having received the wafer W leaves the electroless plating unit (PW) 12, and the windows 44a and 45a are closed.

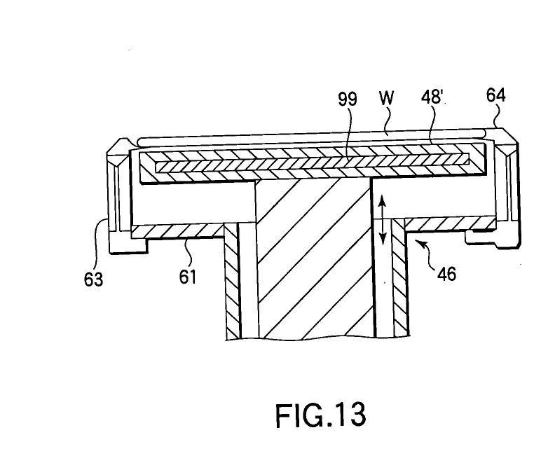

Another example of the under plate for temperature control of the wafer W will be explained next. The under plate 48 is stopped only at two positions, a close position in the vicinity of the wafer W and a separate position apart from the wafer W, supplies a temperature-controlled fluid to the bottom side of the wafer W at the close position to perform temperature control of the wafer W. However, an under plate 48′ incorporating a heater 99 can be used as shown in FIG. 13. This makes it possible to control the temperature of the wafer W with the distance between the wafer W and the under plate 48′ arbitrarily set. Accordingly, the temperature of the wafer W, the speed of the temperature rise, and the like can be controlled finely. It is therefore possible to process wafers W under the temperature condition that provides a plated film with better morphology. The upward/downward movement of the under plate 48 with respect to the wafer W may be performed in multiple steps, or may be performed at a given speed between the close position and the separate position.

If an under plate having both the process-fluid feeding ports and the heater is used, a plated film can be formed with the temperature of the wafer W further raised by moving the under plate moved upward and stopping the under plate at a position at a predetermined distance from the wafer W, first heating the wafer W o a predetermined temperature with the radiation heat of the heater, then feeding heated pure water to the wafer W from the process-fluid feeding ports 81.

Next, a modification of the electroless plating unit (PW) will be explained.

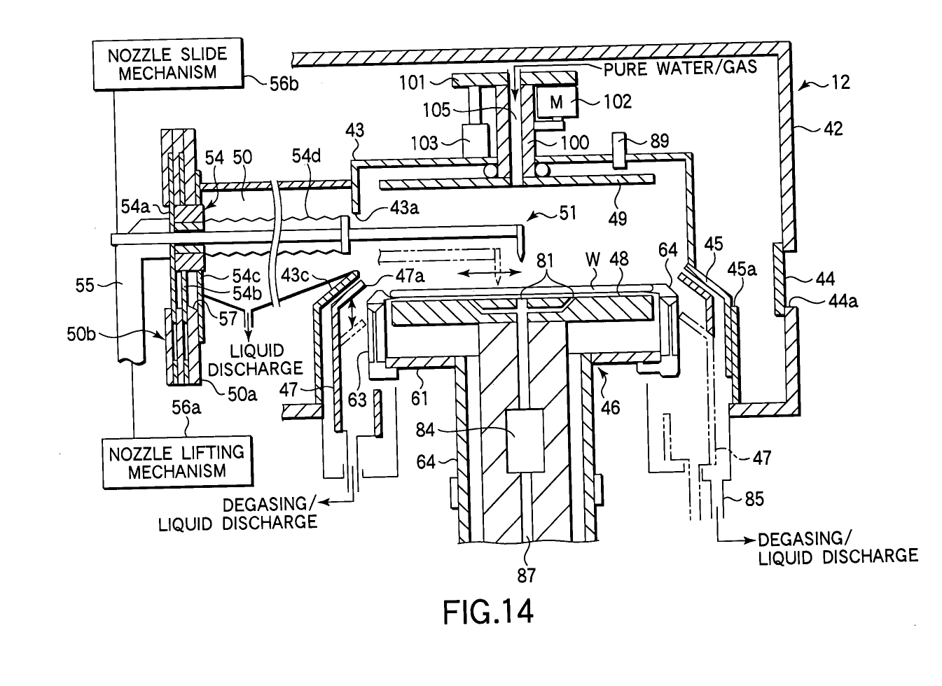

FIG. 14 is a cross-sectional view showing a modification the electroless plating unit (PW). An electroless plating unit (PW) 12′ shown in FIG. 14 is configured to have, in the outer chamber 43, a top plate 49 facing above the wafer W supported by the spin chuck 46. The top plate 49 is connected to the lower end of a pivot 100 and is rotatable by a motor 102. The pivot 100 is rotatably supported on the bottom side of a horizontal plate 101, which is liftable up and down by a lifting mechanism 103, such as an air cylinder, secured to the top wall of the outer chamber 43. A pure-water feeding hole 105 through which pure water can be fed onto the wafer W supported by the spin chuck 46 is provided in the pivot 100 and the top plate 49.

At the time the wafer W is transferred between the spin chuck 46 and one of the transfer arms 34, 35, 36, the top plate 49 is held at a position close to the top wall of the outer chamber 43 so as not to hit against the transfer arm 34, 35, 36. At the time of performing the cleaning process or the electroless plating process on the wafer W, the chemical-solution nozzle 51a or the plating-solution nozzle 51c feeds the chemical solution or the plating solution onto the wafer W to form a paddle thereon, then the top plate 49 is moved downward to contact the paddle, thereby forming a chemical solution layer or a plating solution layer between the top of the wafer W and the top plate 49. At this time, it is preferable to incorporate a heater (not shown) in the top plate 49 so that the temperature of the chemical solution or the plating solution does not drop. The rinse process of the wafer W can be carried out by, for example, rotating the top plate 49 and the wafer W at a predetermined rotational speed while feeding pure water to the wafer W from the pure-water feeding hole 105.

The invention is not limited to the embodiment but can be modified in various other forms. For example, although the under plate is moved upward/downward in the embodiment, the configuration may be modified so that with the under plate fixed at a predetermined height, the interval between a substrate supported by the spin chuck and the under plate is adjusted according to the progress of the plating process by moving the spin chuck up/down. That is, one of the under plate and the substrate supported by the spin chuck has only to be moved up and down in relative to the other. Although the foregoing description of the embodiment has been given of a case where a semiconductor wafer is used as a substrate, the invention is not limited to this particular case, and other substrates, such as a glass substrate for LCD and a ceramic substrate, may be targeted as well.

What is claimed is:

1. An electroless plating apparatus which supplies a plating solution to a top surface of a substrate to effect electroless plating, comprising:
a substrate support section which supports a substrate;
a plating-solution retaining section which retains said plating solution to be supplied to said top surface of said substrate;
a plating-solution feeding pipe which feeds said plating solution from said plating-solution retaining section toward said top surface of said substrate supported by said substrate support section;
a plating-solution discharge nozzle which is provided at said plating-solution feeding pipe and discharges said plating solution to said top surface of said substrate;
a plating-solution temperature controlling mechanism which controls a temperature of said plating solution flowing in said plating-solution feeding pipe; and
a suction mechanism which sucks said plating solution in said plating-solution feeding pipe toward said plating-solution retaining section.

2. The electroless plating apparatus according to claim 1, wherein said plating-solution temperature controlling mechanism has a temperature controlling portion covering at least a part of said plating-solution feeding pipe, and
said suction mechanism sucks said plating solution in said plating-solution feeding pipe toward said plating-solution retaining section until said plating solution passes said temperature controlling portion of said plating-solution temperature controlling mechanism.

3. The electroless plating apparatus according to claim 2, wherein said temperature controlling portion of said plating-solution temperature controlling mechanism is a plating-solution temperature controlling pipe which controls said temperature of said plating solution flowing in said plating-solution feeding pipe as a temperature-controlled fluid whose temperature is controlled to a predetermined temperature flows inside said plating-solution temperature controlling pipe.

4. The electroless plating apparatus according to claim 3, wherein said plating-solution temperature controlling pipe has a double-pipe structure having an inner pipe and an outer pipe, and said temperature-controlled fluid having flowed in one of said inner pipe and said outer pipe flows back in an other one of said inner pipe and said outer pipe.

5. The electroless plating apparatus according to claim 1, wherein said plating-solution temperature controlling mechanism has a temperature controlling portion covering at least a part of said plating-solution feeding pipe, and a heat source which is provided at a portion between said temperature controlling portion and said plating-solution retaining section and heats said plating solution, and
said suction mechanism sucks said plating solution in said plating-solution feeding pipe toward said plating-solution retaining section until said plating solution passes said heat source.

6. The electroless plating apparatus according to claim 5, wherein said temperature controlling portion of said plating-solution temperature controlling mechanism is a plating-solution temperature controlling pipe which controls said temperature of said plating solution flowing in said plating-solution feeding pipe as a temperature-controlled fluid whose temperature is controlled to a predetermined temperature flows inside said plating-solution temperature controlling pipe.

7. The electroless plating apparatus according to claim 6, wherein said plating-solution temperature controlling pipe has a double-pipe structure having an inner pipe and an outer pipe, and said temperature-controlled fluid having flowed in one of said inner pipe and said outer pipe flows back in an other one of said inner pipe and said outer pipe.

8. The electroless plating apparatus according to claim 1, further comprising a chamber which retains said substrate supported by said substrate support section.

9. The electroless plating apparatus according to claim 8, further comprising a moving mechanism which moves said plating-solution feeding pipe in such a way that said plating-solution discharge nozzle moves between a process position on said substrate and a retreat position where said plating-solution discharge nozzle is retreated from said substrate.

10. The electroless plating apparatus according to claim 9, further comprising a nozzle storing chamber which is provided adjacent to said chamber and stores said plating-solution discharge nozzle moved to said retreat position by said moving mechanism.

11. The electroless plating apparatus according to claim 1, further comprising:
a preprocess-liquid feeding mechanism which feeds a predetermined liquid to said substrate prior to feeding of said plating solution to a top surface thereof; and
a postprocess-liquid feeding mechanism which feeds a predetermined liquid to said substrate after feeding of said plating solution to said top surface thereof.

12. The electroless plating apparatus according to claim 1, further comprising a substrate temperature control member which is provided, in a connectable and disconnectable manner, on a bottom side of said substrate supported by said substrate support section, and controls said temperature of said substrate while being close thereto by feeding a temperature-controlled fluid whose temperature is controlled to a predetermined temperature.

13. The electroless plating apparatus according to claim 12, wherein said substrate temperature control member has a function of feeding a dry gas to said substrate.

14. The electroless plating apparatus according to claim 13, further comprising a postprocess-liquid feeding mechanism which feeds a postprocess liquid to said substrate supported by said substrate support section after feeding of said plating solution to said top surface thereof, and
wherein said substrate temperature control member moves downward away from said substrate when or after said postprocess-liquid feeding mechanism feeds said postprocess liquid to said top surface of said substrate, and then moves upward to come close to said substrate again while feeding said dry gas to a bottom side of said substrate from a fluid feeding port, thereby drying said substrate.

15. An electroless plating apparatus which supplies a plating solution to a top surface of a substrate to effect electroless plating, comprising:
a substrate support section which supports a substrate;
a plating-solution retaining section which retains said plating solution to be supplied to said top surface of said substrate;
a plating-solution feeding pipe which feeds said plating solution from said plating-solution retaining section toward said top surface of said substrate supported by said substrate support section;
a plating-solution discharge nozzle which is provided at said plating-solution feeding pipe and discharges said plating solution to said top surface of said substrate;
a substrate temperature control member which is provided on a bottom side of said substrate supported by said substrate support section, and controls a temperature of said substrate; and
a moving mechanism which causes said substrate temperature control member and said substrate to take a relative lift up/down motion.

16. The electroless plating apparatus according to claim 15, wherein said substrate temperature control member incorporates a heater, and heats up said substrate with radiation heat to thereby control said temperature of said substrate to a predetermined temperature.

17. The electroless plating apparatus according to claim 15, wherein said substrate temperature control member controls said temperature of said substrate as a distance between said substrate temperature control member and said substrate is adjusted by said moving mechanism.

18. The electroless plating apparatus according to claim 15, further comprising:
a preprocess-liquid feeding mechanism which feeds a predetermined liquid to said substrate prior to feeding of said plating solution to a top surface thereof; and
a postprocess-liquid feeding mechanism which feeds a predetermined liquid to said substrate after feeding of said plating solution to said top surface thereof.

19. An electroless plating method which performs electroless plating by supplying a plating solution retained in a plating-solution retaining section to a top surface of a substrate via a plating-solution feeding pipe and a plating-solution discharge nozzle, comprising:
controlling a temperature of said plating solution flowing in said plating-solution feeding pipe to a predetermined temperature;
feeding said temperature-controlled plating solution to said top surface of said substrate;
stopping feeding said plating solution to said top surface of said substrate from said plating-solution feeding pipe; and
sucking said plating solution in said plating-solution feeding pipe toward said plating-solution retaining section.

20. The electroless plating method according to claim 19, wherein temperature control of said plating solution is executed by a plating-solution temperature controlling mechanism having a temperature controlling portion covering at least a part of said plating-solution feeding pipe, and
sucking of said plating solution is carried out until said plating solution in said plating-solution feeding pipe passes at least said temperature controlling portion.

21. The electroless plating method according to claim 19, wherein temperature control of said plating solution is executed by a plating-solution temperature controlling mechanism having a temperature controlling portion covering at least a part of said plating-solution feeding pipe, and a heat source which is provided at a portion between said temperature controlling portion and said plating-solution retaining section and heats said plating solution, and
sucking of said plating solution is carried out until said plating solution in said plating-solution feeding pipe passes at least said heat source.

22. The electroless plating method according to claim 19, further comprising controlling a temperature of said substrate at a time of feeding said plating solution thereto.

23. The electroless plating method according to claim 22, wherein said temperature of said substrate is controlled in such a way that said temperature of said substrate when stopping feeding said plating solution is higher than said temperature of said substrate when starting feeding said plating solution.

24. The electroless plating method according to claim 19, further including:
feeding a predetermined liquid to said substrate prior to feeding of said plating solution to a top surface thereof; and
feeding a predetermined liquid to said substrate after feeding of said plating solution to said top surface thereof.

25. An electroless plating method which performs electroless plating by supplying a plating solution retained in a plating-solution retaining section to a top surface of a substrate via a plating-solution feeding pipe and a plating-solution discharge nozzle, comprising:
controlling a temperature of said substrate by adjusting a distance between said substrate and a substrate temperature control member disposed on a bottom side thereof; and
feeding said plating solution flowing in said plating-solution feeding pipe to said top surface of said substrate.

26. The electroless plating method according to claim 25, wherein said temperature of said substrate is controlled in such a way that said temperature of said substrate when stopping feeding said plating solution is higher than said temperature of said substrate when starting feeding said plating solution.

27. The electroless plating method according to claim 25, further including:
feeding a predetermined liquid to said substrate prior to feeding of said plating solution to a top surface thereof; and
feeding a predetermined liquid to said substrate after feeding of said plating solution to said top surface thereof.

28. A computer readable storage medium storing a control program which allows a computer to control an electroless plating apparatus which performs electroless plating by supplying a plating solution to a top surface of a substrate, wherein
said control program, when executed, allows said computer to control said electroless plating apparatus in such a way as to execute an electroless plating method including:
controlling a temperature of said plating solution flowing in said plating-solution feeding pipe to a predetermined temperature;
feeding said temperature-controlled plating solution to said top surface of said substrate;
stopping feeding said plating solution to said top surface of said substrate from said plating-solution feeding pipe; and
sucking said plating solution in said plating-solution feeding pipe toward said plating-solution retaining section.

29. A computer readable storage medium storing a control program which allows a computer to control an electroless plating apparatus which performs electroless plating by supplying a plating solution to a top surface of a substrate, wherein
said control program, when executed, allows said computer to control said electroless plating apparatus in such a way as to execute an electroless plating method including:
controlling a temperature of said substrate by adjusting a distance between said substrate and a substrate temperature control member disposed on a bottom side thereof; and
feeding said plating solution flowing in said plating-solution feeding pipe to said top surface of said substrate.
